(19) United States
(12) Patent Application Publication
(10) Pub. No.: US 2013/0034661 A1
(43) Pub. Date: Feb. 7, 2013

(54) METHOD FOR PROCESSING A SURFACE OF A COMPONENT

(71) Applicants: Stefan Schneiderbanger, Dachau (DE); Manuel Hertter, Muenchen (DE); Andreas Jakimov, Muenchen (DE); Jochen Tewes, Muenchen (DE)

(72) Inventors: Stefan Schneiderbanger, Dachau (DE); Manuel Hertter, Muenchen (DE); Andreas Jakimov, Muenchen (DE); Jochen Tewes, Muenchen (DE)

(73) Assignee: MTU Aero Engines GmbH, Muenchen (DE)

(21) Appl. No.: 13/640,677

(22) PCT Filed: Apr. 6, 2011
(86) PCT No.: PCT/DE2011/000368

§ 371 Date: Oct. 11, 2012

(30) Foreign Application Priority Data
Apr. 22, 2010 (DE) 10 2010 017 859.4

(51) Int. Cl. B05D 7/00; B05D 1/10; B05D 3/12; B05D 1/12

(52) U.S. Cl. 427/446; 427/180

(57) ABSTRACT

A method for processing a surface of a component, in particular in the aviation sector, including the following steps: spraying the component with a first powder and coating the component with a second powder, the first powder having the same chemical composition as the second powder.

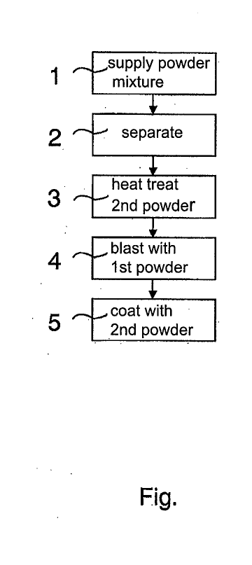

The present invention relates to a method for processing a surface of a component.

Although applicable to any components, the present invention and the problems on which it is based are described here in greater detail with reference to aircraft engines.

### BACKGROUND

In the method known from EP 2 014 415 A1, components of an aircraft engine are first blasted using a first powder having a first chemical composition and are then coated using a second powder having a second chemical composition which is different from the first chemical composition. The coating and the blasting take place with the aid of high velocity oxy-fuel (HVOF) spraying or cold gas spraying. Blasting using the first powder roughens the surface of the component, which is also referred to as activation. The coating adheres well to the roughened surface of the component. The coating formed in this way may function as a wear-resistant coating, for example, which significantly increases the lifetime of the coated component.

With this known method, it has proven to be a disadvantage that, after the blasting, residues of the first powder may remain on the surface of the component and may act as defects in the following coating using the second powder and may thus weaken the bonding of the coating to the component.

### SUMMARY OF THE INVENTION

It is an object of the present invention to provide a method for blasting and coating a component surface, so that the aforementioned disadvantages are at least reduced.

The present invention provides a method for processing a surface of a component, in particular in the aviation sector, having the following steps is provided accordingly: blasting the component using a first powder, and coating the component using a second powder, the first powder having the same chemical composition as the second powder.

The idea on which the present invention is based is to use a powder having the same chemical composition for both blasting and coating. This has the advantage that it is then possible to produce a coating which is free of blasting medium inclusions of any material other than the coating itself, so that good adhesion of the coating to the surface of the component may be ensured.

HVOF spraying stands for high velocity oxy-fuel spraying.

According to a preferred refinement of the present invention, the blasting takes place with the aid of cold gas spraying and/or HVOF spraying. This achieves a roughening of the surface of the component.

According to a preferred refinement of the present invention, the coating takes place with the aid of cold gas spraying and/or HVOF spraying. In this way, a coating adhering strongly to the surface of the component may be produced.

In this context, it should be pointed out that the first and second powders in blasting and coating with the aid of cold gas spraying and/or HVOF spraying are shot onto the surface of the component at a high velocity, for example, at 200 to 500 meters per second using a carrier gas, but they are not fused in the process. Due to the fact that the first and second powders are not fused during spraying, a chemical change in the composition of the first and second powders may be reliably prevented. Blasting and coating preferably take place using the same equipment, in particular using the same HVOF burner or the same cold gas gun.

According to a preferred refinement of the present invention, the powder for blasting has a first particle size and the powder for coating has a second particle size, the first particle size being different from the second particle size. The first particle size is preferably larger than the second particle size. The first particle size is preferably larger than 40 μm and the second particle is between 5 μm and 60 μm. Small particles are required for coating, while large particles are to be preferred for blasting.

According to a preferred refinement of the present invention, the first and second powders are supplied as a mixture, which is separated into the first and second powders before the blasting and coating. This is advantageous in view of the fact that the powder is naturally delivered or supplied as a mixture of particles of different sizes. If this powder mixture is separated into the first powder and the second powder with large and small particle sizes, the entire powder mixture may be used to advantage without resulting in any mentionable waste.

According to a preferred refinement of the present invention, the second powder is subjected to a heat treatment before the coating. Therefore, even brittle metals and ceramics may be used well as a coating material, i.e., as the second powder for coating a surface of the component. The heat treatment may be stress free annealing, soft annealing or solution annealing, for example.

According to a preferred refinement of the present invention, the first and second powders are a nickel-based alloy, e.g., IN718; Nimonic90; Mar M-247; 94Ni—Cr-6Al; titanium alloy, e.g., Ti6Al4V; solder materials, e.g., L-Ag55Sn; copper alloy, e.g., Cu9Al-1Fe; aluminum alloy, e.g., Al-5Cu-1.5Ni-0.25Mn-0.25Sb-0.25Co-0.2Ti-0.2Zr; steels, e.g., Fe-11.8Cr-2.8Ni-1.6Co-1.8Mo-0.32V.

### BRIEF DESCRIPTION OF THE DRAWING

The present invention will now be explained in greater detail on the basis of exemplary embodiments with reference to the accompanying FIGURE of the drawing.

The FIGURE schematically shows several method steps of a method according to an exemplary embodiment of the present invention.

### DETAILED DESCRIPTION

In a first step 1, a powder mixture supplied. The powder mixture naturally has particles of different sizes.

This powder mixture is then separated with the aid of screening in another step 2, for example, into a first powder having a first particle size, for example, larger than 40 μm, and a second powder having a second particle size, for example, between 5 μm and 60 μm.

Hereupon (step 3), the second powder may be heat-treated by stress free annealing, soft annealing or solution annealing, for example.

In another step 4 following or in parallel with step 3, a component, in particular a component of an aircraft engine, for example, a blade, is blasted using the first powder. This may take place with the aid of HVOF spraying or cold gas spraying of the first powder. Suitable spray equipment is used for this purpose, for example, an HVOF burner or a cold gas gun. This roughens, i.e., activates, the surface of the component.

In step 5, the component is coated with the second powder. This may also take place with the aid of HVOF spraying or cold gas spraying of the second powder. In particular the same spray equipment may be used for this as for blasting of the component.

Thus a coating free of blasting medium inclusions of another material than that of the coating itself is produced.

“A” or “one” presently does not preclude a plurality. Furthermore, it should be pointed out that features or steps described in conjunction with one of the above exemplary embodiments may also be used in combination with features or steps of other exemplary embodiments described above.

1-9. (canceled)

10. A method for processing a surface of a component, the method comprising the following steps:
blasting the component using a first powder, and
coating the component using a second powder, the first powder having a same chemical composition as the second powder.

11. The method as recited in claim 10 wherein the blasting occurs with the aid of at least one of cold gas spraying and HVOF spraying.

12. The method as recited in claim 10 wherein the coating occurs with the aid of at least one of cold gas spraying and HVOF spraying.

13. The method as recited in claim 10 wherein the first powder for the blasting has a first particle size and the second powder for the coating has a second particle size, the first particle size being different from the second particle size.

14. The method as recited in claim 13 wherein the first particle size is larger than the second particle size.

15. The method as recited in claim 14 wherein the first particle size is larger than 40 μm, and the second particle size is between 5 μm and 60 μm.

16. The method as recited in claim 10 further comprising supplying the first and second powders as a mixture and separating the mixture into the first powder and the second powder before the blasting and the coating.

17. The method as recited claim 10 further comprising subjecting the second powder to a heat treatment before the coating.

18. The method as recited in claim 10 wherein the first and second powders are at least one of the group consisting of a nickel-based alloy, a titanium alloy, a copper alloy, an aluminum alloy, a steel and a solder material.

19. The method as recited in claim 10 wherein the component is an aviation component.
